(19) United States
(12) Patent Application Publication
(10) Pub. No.: US 2015/0213946 A1
(43) Pub. Date: Jul. 30, 2015

(54) PRINTED WIRING BOARD

(71) Applicant: IBIDEN CO., LTD., Ogaki-shi (JP)

(72) Inventors: Yasuhiko MANO, Ogaki-shi (JP); Takashi KARIYA, Ogaki-shi (JP)

(73) Assignee: IBIDEN CO., LTD., Ogaki-shi (JP)

(21) Appl. No.: 14/604,105

(22) Filed: Jan. 23, 2015

(30) Foreign Application Priority Data
Jan. 24, 2014 (JP) 2014-011185

(51) Int. Cl. H01F 27/28

(52) U.S. Cl. CPC H01F 27/2804; H01F 2027/2809

(57) ABSTRACT

A printed wiring board includes a core substrate, a first buildup layer formed on first-surface side of the substrate, a second buildup layer formed on second-surface side of the substrate, and an inductor component formed on the second-surface side of the substrate. The inductor component includes a base layer, first conductive patterns formed on first surface of the base layer, second conductive patterns formed on second surface of the base layer and through-hole conductors connecting the first and second conductive patterns through the base layer such that the inductor component has an inductor structure having the first conductive patterns, the second conductive patterns and the through-hole conductors, and the base layer of the inductor component has a magnetic body structure including magnetic material such that the magnetic body structure is positioned on an inner side of the inductor structure.

### CROSS-REFERENCE TO RELATED APPLICATIONS

The present application is based upon and claims the benefit of priority to Japanese Patent Application No. 2014-011185, filed Jan. 24, 2014, the entire contents of which are incorporated herein by reference.

### BACKGROUND OF THE INVENTION

1. Field of the Invention

The present invention relates to a printed wiring board having an inductor component.

2. Description of Background Art

JP2008-270532A describes an inductor component manufactured by pressing a thick metal plate (for example, 100˜300 μm). The inductor component is adhered onto a substrate. Then, in JP2008-270532A, a buildup layer is formed on the substrate and on the inductor component. The entire contents of this publication are incorporated herein by reference.

### SUMMARY OF THE INVENTION

According to one aspect of the present invention, a printed wiring board includes a core substrate, a first buildup layer formed on a first-surface side of the core substrate, a second buildup layer formed on a second-surface side of the core substrate on the opposite side with respect to the first-surface side, and an inductor component formed on the second-surface side of the core substrate. The inductor component includes a core base layer, first conductive patterns formed on a first surface of the core base layer, second conductive patterns formed on a second surface of the core base layer on the opposite side with respect to the first surface of the core base layer and through-hole conductors connecting the first conductive patterns and the second conductive patterns through the core base layer such that the inductor component has an inductor structure having the first conductive patterns, the second conductive patterns and the through-hole conductors, and the core base layer of the inductor component has a magnetic body structure including magnetic material such that the magnetic body structure is positioned on an inner side of the inductor structure.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a cross-sectional view of an inductor component according to a first embodiment of the present invention;

FIGS. 2(A) and 2(C) are plan views of the inductor in the first embodiment, and FIG. 2(B) is a side view;

FIG. 3(A)-3(E) are views showing steps in a method for manufacturing an inductor component according to the first embodiment;

FIG. 4(A)-4(E) views showing steps in a method for manufacturing an inductor component according to the first embodiment;

FIG. 5(A)-5(C) views showing steps in a method for manufacturing an inductor component according to the first embodiment;

FIG. 6 is a view showing steps in a method for manufacturing an inductor component according to the first embodiment;

FIG. 7 is a cross-sectional view of a printed wiring board with a built-in inductor component according to a first modified example of the first embodiment;

FIG. 8 is a cross-sectional view of a printed wiring board with a built-in inductor component according to a second modified example of the first embodiment; and

FIG. 9 is a cross-sectional view of an inductor component according to a third modified example of the first embodiment.

### DETAILED DESCRIPTION OF THE EMBODIMENTS

The embodiments will now be described with reference to the accompanying drawings, wherein like reference numerals designate corresponding or identical elements throughout the various drawings.

### First Embodiment

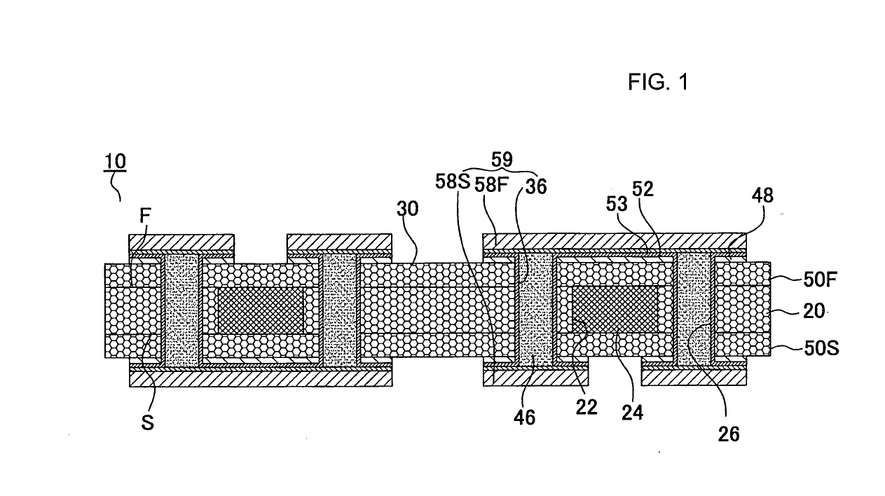

FIG. 1 is a cross-sectional view of an inductor component according to a first embodiment.

Inductor component 10 is structured with the following: core base 20 with magnetic body 24 containing a magnetic material in opening 22; first resin insulation layer (50F) formed on the first-surface (F) side of the core base; second resin insulation layer (50S) formed on the second-surface (S) side of the core base; first conductive patterns (58F) formed on first resin insulation layer (50F); second conductive patterns (58S) formed on second resin insulation layer (50S); and through-hole conductors 36 connecting first conductive patterns (58F) and second conductive patterns (58S). The thickness of the core base is preferred to be 0.1 mm˜0.5 mm.

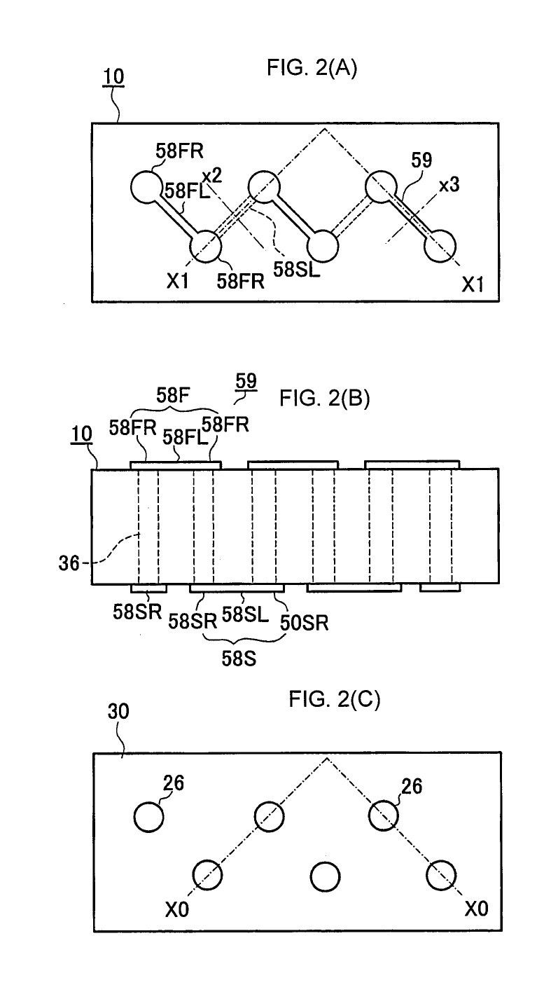

FIG. 2(A) is a plan view and FIG. 2(B) is a side view of inductor component 10. First conductive pattern (58F) on the first-surface side is made up of through-hole lands (58FR) each formed directly on through-hole conductor 36 and of connection pattern (58FL) connecting through-hole lands (58FR) to each other. Second conductive pattern (58S) on the second-surface side is made up of through-hole lands (58SR) each formed directly beneath through-hole conductor 36 and of connection pattern (58SL) connecting through-hole lands (58SR) to each other. First conductive patterns (58F) and second conductive patterns (58S) are connected by through-hole conductors 36 to form a helical shape. Inductor 59 is formed with first conductive patterns (58F), second conductive patterns (58S) and through-hole conductors 36.

FIG. 1 corresponds to a cross section taken at the (X1-X1) in FIG. 2(A). In inductor component 10, resin insulation layer (50F) is formed on first surface (F) of core base 20, and first conductive patterns (58F) are formed on resin insulation layer (50F) as shown in the drawings. Resin insulation layer (50S) is formed on second surface (S) of core base 20, and second conductive patterns (58S) are formed on resin insulation layer (50S). Through-hole conductors 36 connecting first conductive patterns (58F) and second conductive patterns (58S) are formed in penetrating holes 26 in core base 20. Filler resin 46 is filled in through-hole conductors 36. It is an option for through-hole conductors 36 to be filled with plating and not to have filler resin.

In the inductor component of the first embodiment, first conductive patterns (58F) and second conductive patterns (58S) on upper and lower surfaces of core base 20 are connected by through-hole conductors 36 in the core base to make a helical shape so that an inductor is formed. Magnetic flux concentrates in the space surrounded by first conductive patterns (58F) and second conductive patterns (58S) disposed in a helical shape. Since magnetic material (magnetic body) 24 is present in a portion where magnetic flux concentrates, the density of magnetic flux increases and desired inductance characteristics (inductance value, Q factor) are achieved.

In the inductor component of the first embodiment, conductive patterns (58F, 58S) are provided on resin insulation layers (50F, 50S) on core base 20. Since conductive patterns are formed on resin insulation layers, it is easier to secure adhesiveness of conductive patterns in this situation than in a situation where conductive patterns are in contact with a magnetic body.

The inductor component of the first embodiment, magnetic body 24 and through-hole conductors 36 are formed respectively in openings and in penetrating holes in the core base. Accordingly, magnetic body 24 and through-hole conductors 36 are prevented from making contact with each other. As a result, adhesiveness of through-hole conductors is easier to maintain.

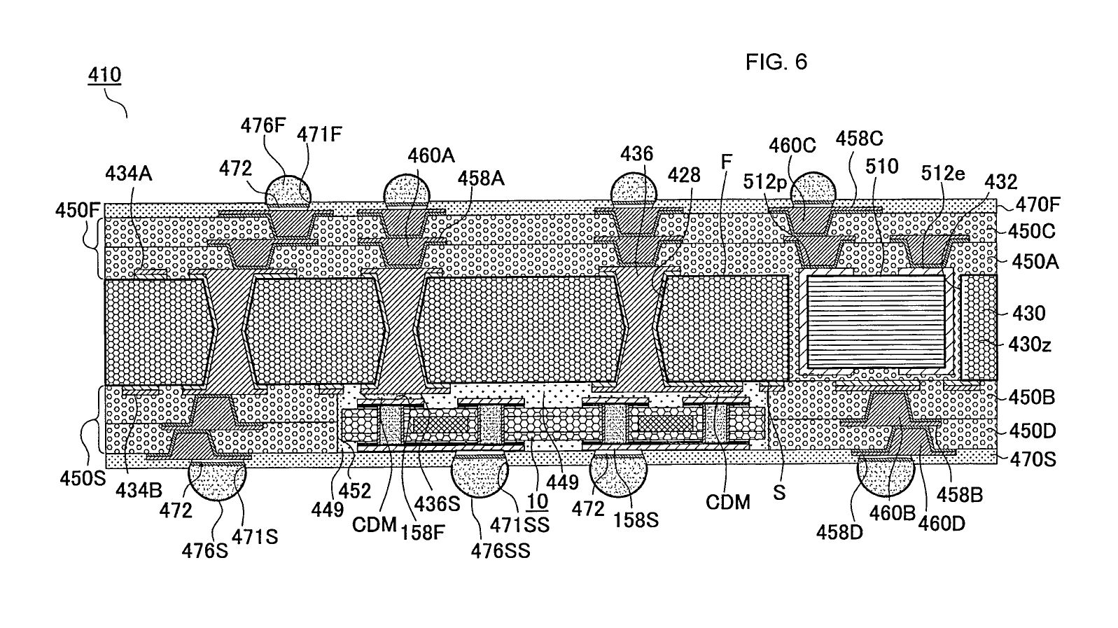

FIG. 6 shows a cross-sectional view of printed wiring board 410 with a built-in inductor component of the first embodiment. Printed wiring board 410 has core substrate 430 which is made up of insulative base (430z) with first surface (F) and second surface (S) opposite first surface (F), first conductive layer (434A) on first surface (F) of the insulative base, second conductive layer (434B) on second surface (S) of the insulative base, and through-hole conductors 436 connecting first conductive layer (434A) and second conductive layer (434B). The core substrate has first surface (F) and second surface (S) opposite the first surface (F). The first surface of the core substrate corresponds to the first surface of the insulative base, and the second surface of the core substrate corresponds to the second surface of the insulative base.

Through-hole conductors 436 are formed by filling plating film in penetrating holes 428 formed in insulative base (430z). Moreover, penetrating hole 432 is formed in insulative base (430z), and laminated ceramic capacitor 510 is accommodated in the penetrating hole. Laminated ceramic capacitor 510 has electrodes (512p, 512e).

Printed wiring board 410 further includes upper buildup layer (450F) on first surface (F) of core substrate 430. Upper buildup layer (450F) has insulation layer (upper interlayer resin insulation layer) (450A) on first surface (F) of core substrate 430, conductive layer (upper conductive layer) (458A) on insulation layer (450A), and via conductors (upper via conductors) (460A) which penetrate through insulation layer (450A) and connect conductive layer (458A) to first conductive layer (434A), through-hole conductors 436, and electrodes (512p, 512e) of laminated ceramic capacitor 510. Upper buildup layer (450F) further includes insulation layer (uppermost interlayer resin insulation layer) (450C) formed on insulation layer (450A) and conductive layer (458A), conductive layer (uppermost conductive layer) (458C) formed on insulation layer (450C), and via conductors (uppermost via conductors) (460C) which penetrate through insulation layer (450C) and connect conductive layer (458C) to conductive layer (458A) and via conductors (460A).

Printed wiring board 410 further includes lower buildup layer (450S) formed on second surface (S) of core substrate 430. Lower buildup layer (450S) has insulation layer (lower interlayer resin insulation layer) (450B) on second surface (S) of core substrate 430, conductive layer (lower conductive layer) (458B) on insulation layer (450B), and via conductors (lower via conductors) (460B) which penetrate through insulation layer (450B) and connect conductive layer (458B) to second conductive layer (434B) and through-hole conductors 436. Lower buildup layer (450S) further includes insulation layer (lowermost interlayer resin insulation layer) (450D) formed on insulation layer (450B) and conductive layer (458B), conductive layer (lowermost conductive layer) (458D) formed on insulation layer (450D), and via conductors (lowermost via conductors) (460D) which penetrate through insulation layer (450D) and connect conductive layer (458D) to conductive layer (458B) and via conductors (460B).

Lower buildup layer (450S) of printed wiring board 410 contains inductor component 10. In the first embodiment, the lower buildup layer of printed wiring board 410 has cavity 452 to accommodate inductor component 10. Printed wiring board 410 of the first embodiment has inductor component 10 accommodated in cavity 452. In the first embodiment, cavity 452 penetrates through the lower buildup layer. The second surface of the core substrate and the lower surfaces of through-hole conductors (lower through-hole lands) (436S) are exposed in the cavity. Cavity 452 is formed in lower and lowermost interlayer resin insulation layers (450B, 450D).

First conductive layer (158F) of inductor component 10 and the lands (lower through-hole lands) (436S) of through-hole conductors 436 are electrically connected by a conductive material (bonding material). The bonding material is solder, conductive paste, or anisotropic conductive film, for example. Each inductor 59 of inductor component 10 is positioned to form a helical shape that loops around axes (x2, x3) parallel to the upper and lower surfaces of core substrate 430 (see FIG. 2(A)).

The space between inductor component 10 and the sidewalls of the lower buildup layer exposed in cavity 452 may be filled with filler resin 449. The space between the inductor component and the second surface of core substrate 430 or through-hole conductors may also be filled with filler resin 449. Filler resin 449 may contain magnetic particles. The Q factor and inductance value of the inductor are unlikely to decrease. Examples of magnetic particles are ferric oxide, cobalt-coated iron oxide, iron and permalloy.

Moreover, in the printed wiring board of the first embodiment, solder-resist layer (470F) having openings (471F) is formed on upper buildup layer (450F), and solder-resist layer (470S) having openings (471S, 471SS) is formed on lower buildup layer (450S) and on inductor component 10. The second-surface side of inductor component 10 is covered with solder-resist layer (470S) formed on the lower buildup layer. Thus, it is not necessary for the inductor component to have a solder-resist layer on its second surface side.

Upper surfaces of conductive layers (458C, 458D) and via conductors (460C, 460D) exposed through openings (471F, 471S) of solder-resist layers (470F, 470S) work as pads. Protective film 472 made of Ni/Au, Ni/Pd/Au, Pd/Au or OSP is formed on those pads. Solder bumps (476F, 476S) are formed on the protective film. An IC chip (not shown) is mounted on printed wiring board 410 through solder bumps (476F) formed on upper buildup layer (450F). Printed wiring board 410 is mounted on a motherboard through solder bumps (476S) formed on lower buildup layer (450S).

Solder-resist layer (470S) further includes opening (471SS) to expose second conductive layer (158S) of the inductor component. Protective film 472 may also be formed on the second conductive layer. Bonding members (476SS) such as solder bumps are formed on second conductive layer (158S). Bonding members other than solder bumps are conductive paste, anisotropic conductive rubber or the like.

In the first embodiment, inductor 59 is formed in a helical shape, looping around an axis parallel to a planar surface of core substrate 430 of a printed wiring board. Namely, since the inductor loops not in a thickness direction but in a lateral direction of a printed wiring board, the number of turns is made greater and desired inductance characteristics (inductance value, Q factor) are achieved without increasing the thickness of the printed wiring board. In addition, since inductor component 10 is positioned on the second-surface side of a printed wiring board, the inductor component is located directly under a semiconductor mounted on the first surface. Accordingly, the wiring length between the semiconductor and the inductor component is shortened, and fast and efficient power transmission to the semiconductor is achieved.

### Method for Manufacturing Inductor Component of the First Embodiment

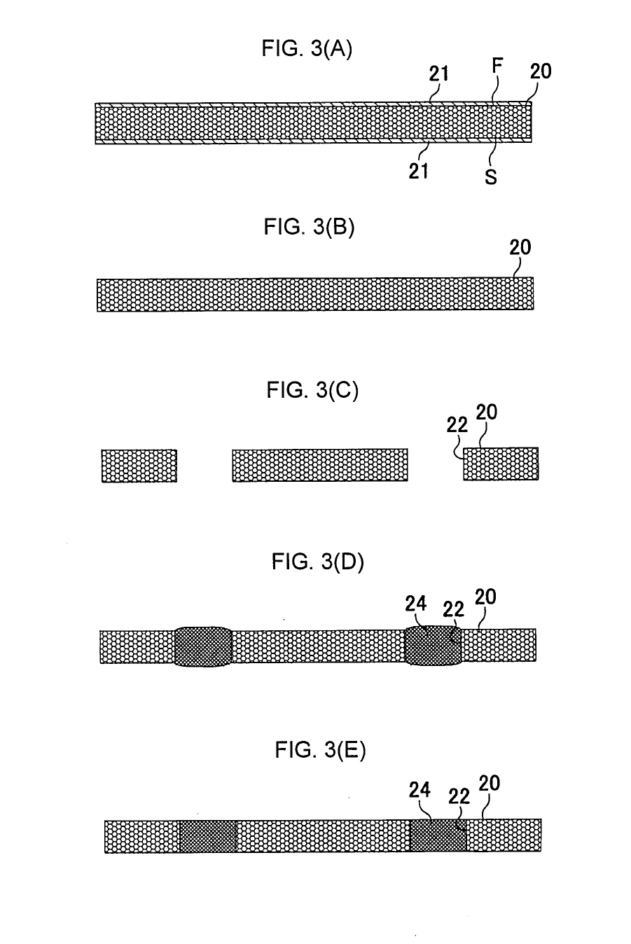

FIG. 3˜5 show a method for manufacturing an inductor component according to the first embodiment.

A 0.15 mm-thick core base 20 is prepared. Copper foils 21 are laminated on core base 20 (FIG. 3(A)). Copper foils are etched away (FIG. 3(B)). Then, openings 22 are formed by router processing (FIG. 3(C)). By vacuum metal stencil printing, magnetic body 24 is provided in openings 22 (FIG. 3(D)). Magnetic material is a complex material made of magnetic metal and organic material such as resin. To achieve desired inductance characteristics (inductance value, Q factor), the magnetic material is preferred to have a permeability of 2˜20 and a magnetic saturation of 0.1 T˜2 T. Core base 20 is belt polished and smoothed to have a surface irregularity of ±10 μm (FIG. 3(E)).

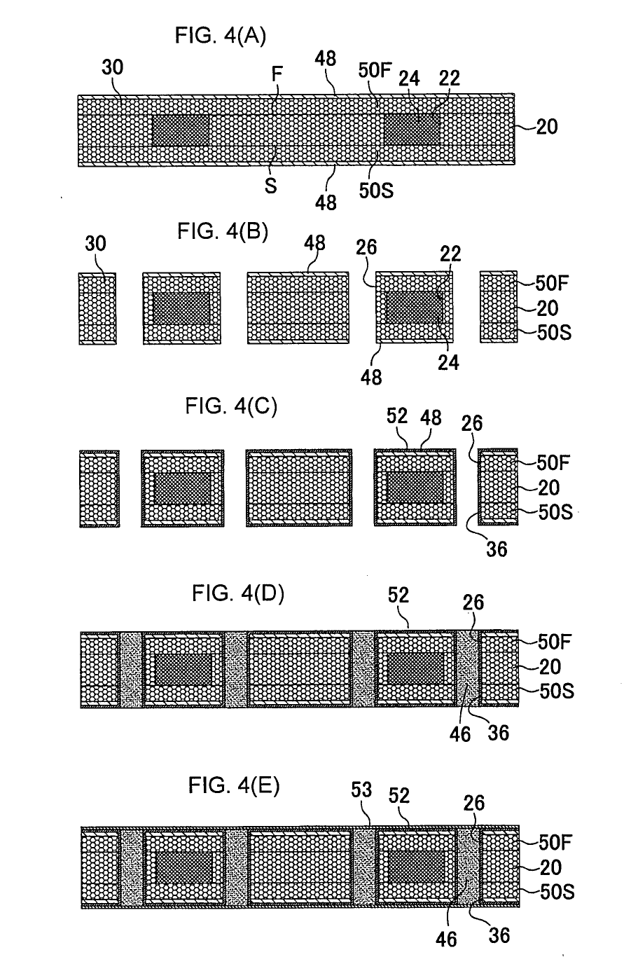

On first surface (F) and second surface (S) of core base 20, a 40 μm-thick prepreg and 12 μm-thick copper foil are laminated to form first resin insulation layer (50F) and second resin insulation layer (50S). Accordingly, laminate 30 is completed (FIG. 4(A)). Using a laser or a drill, penetrating holes 26 are formed where through-hole conductors are to be provided in laminate 30 (FIG. 4(B)). A plan view of laminate 30 is shown in FIG. 2(C)). FIG. 4(B) corresponds to a cross section taken at (X0-X0) in FIG. 2(C).

Plated film 52 made up of electroless plating and electrolytic plating is formed on copper foil 48 and on the inner walls of penetrating holes 26. Plated film 52 formed on the inner walls of penetrating holes 26 makes through-hole conductors 36 (FIG. 4(C)). Resin filler 46 is filled in through-hole conductors 36 (FIG. 4(D)). Electroless plated film 53 is formed on plated film 52 and on resin filler 46 exposed in through-hole conductors (FIG. 4(E)). In the first embodiment, resin filler is filled in through-hole conductors. However, it is an option to fill through-hole conductors with plating.

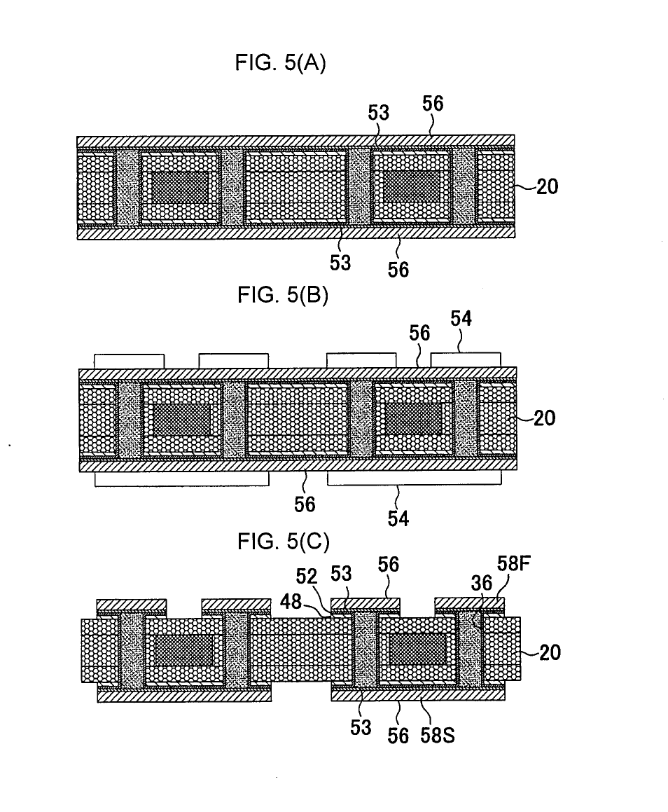

Electrolytic plated film 56 is formed on electroless plated film 53 (FIG. 5(A)), etching resist 54 with a predetermined pattern is formed on electrolytic plated film 56 (FIG. 5(B)). Then, electrolytic plated film 56, electroless plated film 53, plated film 52 and copper foil 48 are removed from where no etching resist is formed. Next, the etching resist is removed to form first conductive patterns (58F) and second conductive patterns (58S) (FIG. 5(C)). An inductor component is completed (FIG. 1). Since the same method for manufacturing a printed wiring board is used for forming an inductor component of the first embodiment, its manufacturing method is simplified.

### First Modified Example of First Embodiment

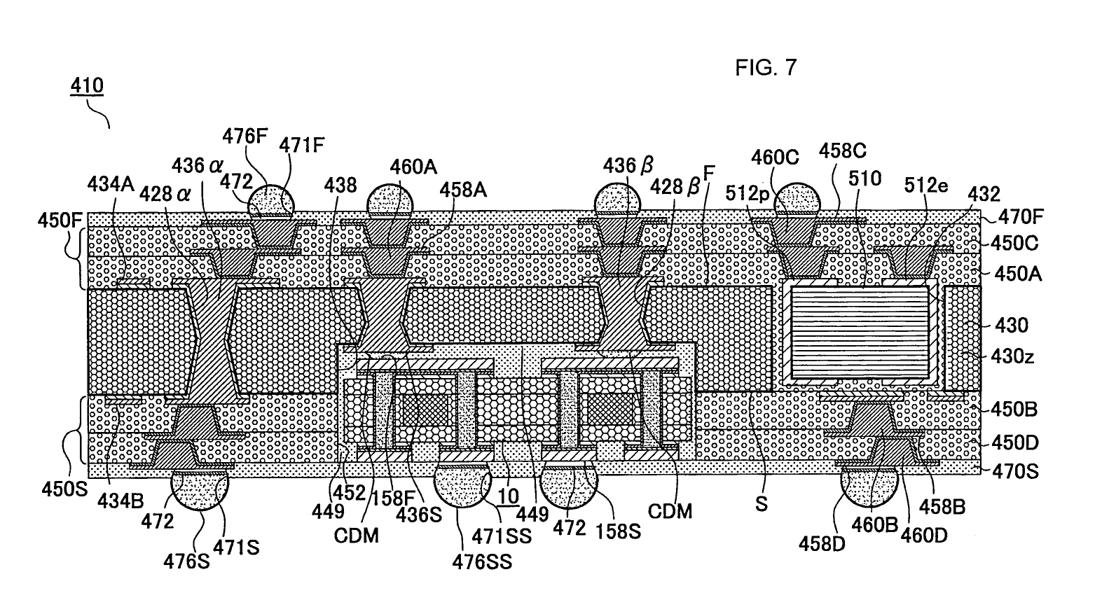

FIG. 7 shows a cross-sectional view of printed wiring board 410 according to a first modified example of the first embodiment. Printed wiring board 410 has core substrate 430 which is made up of insulative base (430z) having first surface (F) and second surface (S) opposite first surface (F), first conductive layer (434A) on first surface (F) of the insulative base, second conductive layer (434B) on second surface (S) of the insulative base, and through-hole conductors 436 connecting first conductive layer (434A) and second conductive layer (434B). The core substrate has first surface (F) and second surface (S) opposite first surface (F).

According to the first modified example of the first embodiment, core substrate 430 and a lower buildup layer of printed wiring board 410 accommodate inductor component 10. To accommodate inductor component 10 in the first modified example of the first embodiment, lower buildup layer (450S) of printed wiring board 410 has cavity 452 and core substrate 430 has second cavity 438 which is connected to cavity 452.

Core substrate 430 includes first through-hole conductors (436α) which reach the second surface and second through-hole conductors (436β) which reach second cavity 438. First through-hole conductors (436α) are formed by filling plated film in first penetrating holes (428α) which reach the second surface. Second through-hole conductors (436β) are formed by filling plated film in second penetrating holes (428β) which reach second cavity 438. Lower surfaces (lower through-hole lands) (436S) of second through-hole conductors (436β) are exposed in second cavity 438.

First conductive layer (158F) of inductor component 10 and lands (lower through-hole lands) (436S) of second through-hole conductors (436β) are electrically connected by a conductive material (bonding material). Examples of such a bonding material are solder, conductive paste and anisotropic conductive film.

The space between inductor component 10 and the sidewalls exposed in cavity 452 or in second cavity 438 may be filled with filler resin 449. The space between the inductor component and the bottom surface of second cavity 438 or lands (436S) of through-hole conductors may also be filled with filler resin 449. Filler resin 449 may contain magnetic particles. The Q factor or inductance value of the inductor is unlikely to be lowered. Examples of magnetic particles are ferric oxide, cobalt-coated iron oxide, iron and permalloy.

A thicker inductor component can be accommodated in a printed wiring board according to the first modified example of the first embodiment.

### Second Modified Example of First Embodiment

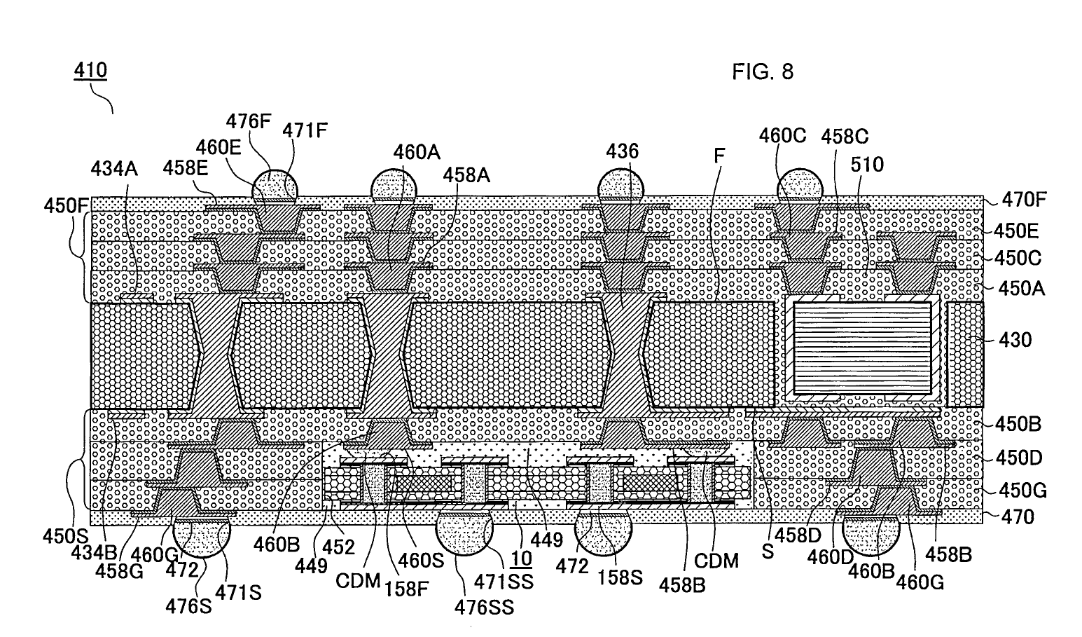

FIG. 8 shows a cross-sectional view of printed wiring board 410 according to a second modified example of the first embodiment. Printed wiring board 410 includes core substrate 430 which is made up of insulative base (430z) having first surface (F) and second surface (S) opposite first surface (F), first conductive layer (434A) on first surface (F) of the insulative base, second conductive layer (434B) on second surface (S) of the insulative base, and through-hole conductors 436 connecting first conductive layer (434A) and second conductive layer (434B).

Printed wiring board 410 further includes upper buildup layer (450F) formed on first surface (F) of core substrate 430. Upper buildup layer (450F) has insulation layer (interlayer resin insulation layer) (450A) on first surface (F) of core substrate 430, conductive layer (458A) on insulation layer (450A), and via conductors (460A) which penetrate through insulation layer (450A) and connect conductive layer (458A) to first conductive layer (434A), through-hole conductors 436 and electrodes (512p, 512e) of laminated ceramic capacitor 510. Upper buildup layer (450F) further includes insulation layer (450C) formed on insulation layer (450A) and conductive layer (458A), conductive layer (458C) formed on insulation layer (450C), and via conductors (460C) which penetrate through insulation layer (450C) and connect conductive layer (458C) to conductive layer (458A) and via conductors (460A). Upper buildup layer (450F) further includes insulation layer (uppermost interlayer resin insulation layer) (450E) formed on insulation layer (450C) and conductive layer (458C), conductive layer (uppermost conductive layer) (458E) formed on insulation layer (450E), and via conductors (uppermost via conductor) (460E) which penetrate through insulation layer (450E) and connect conductive layer (458E) to conductive layer (458C) and via conductors (460C).

Printed wiring board 410 further includes lower buildup layer (450S) formed on second surface (S) of core substrate 430. Lower buildup layer (450S) has insulation layer (interlayer resin insulation layer) (450B) on second surface (S) of core substrate 430, conductive layer (458B) on insulation layer (450B), and via conductors (460B) which penetrate through insulation layer (450B) and connect conductive layer (458B) to second conductive layer (434B), and through-hole conductors 436. Lower buildup layer (450S) further includes insulation layer (interlayer resin insulation layer) (450D) formed on insulation layer (450B) and conductive layer (458B), conductive layer (458D) formed on insulation layer (450D), and via conductors (460D) which penetrate through insulation layer (450D) and connect conductive layer (458D) to conductive layer (458B) and via conductors (460B). Lower buildup layer (450S) further includes insulation layer (lowermost interlayer resin insulation layer) (450G) formed on insulation layer (450D) and conductive layer (458D), conductive layer (lowermost conductive layer) (458G) formed on insulation layer (450G), and via conductors (lowermost via conductors) (460G) which penetrate through insulation layer (450G) and connect conductive layer (458G) to conductive layer (458D) and via conductors (460D).

Lower buildup layer (450S) of printed wiring board 410 contains inductor component 10. In the second modified example of the first embodiment, the lower buildup layer of printed wiring board 410 has cavity 452 for accommodating inductor component 10. Then, inductor component 10 is accommodated in cavity 452 formed in printed wiring board 410 of the second modified example of the first embodiment. Cavity 452 is formed in interlayer resin insulation layer (450D) and lowermost interlayer resin insulation layer (450G). The surfaces of interlayer resin insulation layer (450B), conductive layer (458B) on interlayer resin insulation layer (450B) and lands (460S) of via conductors (460B) are exposed in the cavity.

First conductive layer (158F) of inductor component 10 is electrically connected to lands (lower via lands) (460S) of via conductors (460B) and conductive layer (458B) by a conductive material (bonding material). Examples of such a bonding material are solder, conductive paste and anisotropic conductive film.

The space between inductor component 10 and the sidewalls of lower build-up layer exposed in cavity 452 may be filled with filler resin 449. The space between the inductor component and the surface of interlayer resin insulation layer (450B), via land (460S) or conductive layer (458B) exposed in cavity 452 may also be filled with filler resin 449. Filler resin 449 may contain magnetic particles.

Since rigidity is provided for a printed wiring board according to the second modified example of the first embodiment, warping or the like is less likely to occur.

### Third Modified Example of First Embodiment

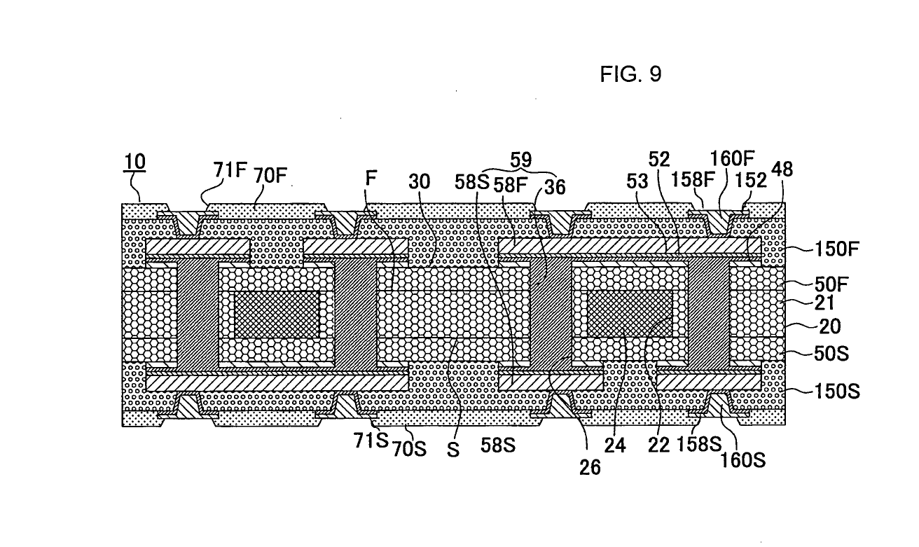

FIG. 9 is a cross-sectional view of an inductor component according to a third modified example of the first embodiment. Inductor component 10 has buildup layers on the first and second surfaces of the core substrate. Uppermost interlayer resin insulation layer (150F) is formed on resin insulation layer (50F) and first conductive patterns (58F), and first conductive layer (158F) is formed on uppermost interlayer resin insulation layer (150F). First conductive patterns (58F) and first conductive layer (158F) are connected by via conductor (160F). Solder-resist layer (70F) is formed on uppermost interlayer resin insulation layer (150F) and first conductive layer (158F). First conductive layer (158F) exposed in openings (71F) of the solder-resist layer work as pads.

Lowermost resin insulation layer (150S) is formed on resin insulation layer (50S) and second conductive patterns (58S), and second conductive layer (158S) is formed on lowermost interlayer resin insulation layer (150S). Second conductive patterns (58S) and second conductive layer (158S) are connected by via conductor (160S). Solder-resist layer (70S) is formed on lowermost interlayer resin insulation layer (150S) and second conductive layer (158S). Second conductive layer (158S) exposed in openings (71S) of the solder-resist layer work as pads.

Magnetic material is contained in uppermost interlayer resin insulation layer (150F) and lowermost interlayer resin insulation layer (150S). Thus, magnetic flux is less likely to leak. First conductive patterns (58F) formed on first resin insulation layer (50F) and second conductive patterns (58S) formed on second resin insulation layer (50S) are set to have a greater thickness than that of first conductive layer (158F) on uppermost interlayer resin insulation layer (150F) and second conductive layer (158S) on lowermost interlayer resin insulation layer (150S). Accordingly, electric resistance is low in first conductive patterns (58F) and second conductive patterns (58S). Through-hole conductors 36 are formed by filling plating in penetrating holes 26.

When an inductor component is made of a metal plate, spiral inductor patterns are laminated, and it is thought to be difficult to connect inductor patterns in different layers. It is also thought that plating is not used for forming inductor patterns in a laminated inductor component. Considering those viewpoints, it is thought to be difficult to laminate inductor patterns and to increase the inductance value by using the method in JP2008-270532A.

A printed wiring board with a built-in inductor component according to an embodiment of the present invention is capable of achieving desired inductance characteristics (inductance value, Q factor).

A printed wiring board according to one aspect of the present invention includes a core substrate having a first surface and a second surface opposite the first surface; an upper buildup layer formed on the first-surface side of the core substrate; a lower buildup layer formed on the second-surface side of the core substrate; and an inductor component on the second-surface side. The inductor component includes a core base having a main surface, a secondary surface opposite the main surface, and penetrating holes; first conductive patterns formed on the main surface of the core base; second conductive patterns formed on the secondary surface of the core base; and through-hole conductors which are formed in penetrating holes and connect the first conductive patterns and second conductive patterns. The inductor component includes an inductor which is made up of first conductive patterns, second conductive patterns and through-hole conductors and which is in a helical shape formed around an axis parallel to the upper and lower surfaces of the core substrate. In the core base, a magnetic body made of magnetic material is provided at least on the inner side of the inductor.

In a printed wiring board according to an embodiment of the present invention, since an inductor is in a helical shape formed along an axis parallel to a planar surface of the core substrate, the inductor loops not in a thickness direction of a printed wiring board but in a lateral direction. Accordingly, the number of turns is made greater without increasing the thickness of the printed wiring board, and desired inductance characteristics (inductance value, Q factor) are achieved. In addition, since an inductor component is positioned on the second-surface side of a printed wiring board, the inductor component is located directly under a semiconductor mounted on the first surface. Accordingly, the wiring length between the semiconductor and the inductor component is shortened, and faster and more efficient power transmission to the semiconductor is achieved.

Obviously, numerous modifications and variations of the present invention are possible in light of the above teachings. It is therefore to be understood that within the scope of the appended claims, the invention may be practiced otherwise than as specifically described herein.

What is claimed is:

1. A printed wiring board, comprising:
a core substrate;
a first buildup layer formed on a first-surface side of the core substrate;
a second buildup layer formed on a second-surface side of the core substrate on an opposite side with respect to the first-surface side; and
an inductor component formed on the second-surface side of the core substrate,
wherein the inductor component includes a core base layer, a plurality of first conductive patterns formed on a first surface of the core base layer, a plurality of second conductive patterns formed on a second surface of the core base layer on an opposite side with respect to the first surface of the core base layer and a plurality of through-hole conductors connecting the first conductive patterns and the second conductive patterns through the core base layer such that the inductor component has an inductor structure comprising the first conductive patterns, the second conductive patterns and the through-hole conductors, and the core base layer of the inductor component has a magnetic body structure comprising magnetic material such that the magnetic body structure is positioned on an inner side of the inductor structure.

2. A printed wiring board according to claim 1, wherein the first conductive patterns, the second conductive patterns and the through-hole conductors are formed in a helical shape around an axis parallel to a first surface of the core substrate and to a second surface of the core substrate on an opposite side with respect to the first surface of the core substrate.

3. A printed wiring board according to claim 1, wherein the inductor component is accommodated in a cavity portion penetrating through the second buildup layer.

4. A printed wiring board according to claim 1, wherein the inductor component is accommodated in a cavity portion formed in the core substrate and a cavity portion penetrating through the second buildup layer and connected to the cavity portion formed in the core substrate.

5. A printed wiring board according to claim 1, wherein the inductor component is accommodated in a cavity portion formed in the second buildup layer.

6. A printed wiring board according to claim 1, wherein the magnetic body structure comprises a magnetic metal material and an organic material.

7. A printed wiring board according to claim 1, further comprising:
a capacitor component positioned in the core substrate.

8. A printed wiring board according to claim 1, wherein the magnetic material of the magnetic body structure has a permeability in a range of from 2 to 20 and a magnetic saturation in a range of from 0.1 T to 2 T.

9. A printed wiring board according to claim 1, wherein the inductor component includes a first resin insulation layer formed on the first surface of the core base layer and a second resin insulation layer formed on the second surface of the core base layer, and the magnetic body structure comprises a magnetic body layer comprising the magnetic material filling a penetrating hole formed through the core base layer.

10. A printed wiring board according to claim 1, wherein the core base layer has a thickness in a range of from 0.1 mm to 0.5 mm.

11. A printed wiring board according to claim 1, wherein the inductor component includes a buildup layer formed on the plurality of first conductive patterns and comprising an interlayer resin insulation layer and a conductive layer, and the plurality of first conductive patterns has a thickness which is greater than a thickness of conductive layer.

12. A printed wiring board according to claim 1, wherein the through-hole conductors comprises plated material filling a plurality of through holes penetrating through the core base layer, respectively.

13. A printed wiring board according to claim 1, wherein the magnetic body structure comprises a plurality of magnetic bodies formed in the core base layer.

14. A printed wiring board according to claim 1, further comprising:
a plurality of first solder bumps formed on the first buildup layer such that the plurality of first solder bumps is positioned to mount an electronic component; and
a plurality of second solder bumps formed on the second buildup layer such that the plurality of second solder bumps is positioned to mount a motherboard.

15. A printed wiring board according to claim 14, further comprising a plurality of through-hole conductors formed through the core substrate and connecting the first buildup layer and the second buildup layer.

16. A printed wiring board according to claim 1, wherein the magnetic body structure comprises at least one magnetic metal material selected from the group consisting of ferric oxide, cobalt-coated iron oxide, iron and permalloy.

17. A printed wiring board according to claim 2, wherein the magnetic material of the magnetic body structure has a permeability in a range of from 2 to 20 and a magnetic saturation in a range of from 0.1 T to 2 T.

18. A printed wiring board according to claim 2, wherein the inductor component includes a first resin insulation layer formed on the first surface of the core base layer and a second resin insulation layer formed on the second surface of the core base layer, and the magnetic body structure comprises a magnetic body layer comprising the magnetic material filling a penetrating hole formed through the core base layer.

19. A printed wiring board according to claim 2, wherein the core base layer has a thickness in a range of from 0.1 mm to 0.5 mm.

20. A printed wiring board according to claim 2, wherein the inductor component includes a buildup layer formed on the plurality of first conductive patterns and comprising an interlayer resin insulation layer and a conductive layer, and the plurality of first conductive patterns has a thickness which is greater than a thickness of conductive layer.
